(19) United States
(12) Patent Application Publication
(10) Pub. No.: US 2005/0211033 A1
(43) Pub. Date: Sep. 29, 2005

(54) Method of cutting polymer film

(75) Inventor: Minoru Matsuura, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: Fuji Photo Film Co., Ltd.

(21) Appl. No.: 11/086,435

(22) Filed: Mar. 23, 2005

(30) Foreign Application Priority Data
Mar. 23, 2004 (JP) 2004-084012

(51) Int. Cl. B26D 1/00

(52) U.S. Cl. 83/13

(57) ABSTRACT

A film, whose a glass transition temperature of a polymer is Tg, is heated so as to satisfy a formula, (Tg−90)≦T≦(Tg−30). The heating is made by feeding a warm air from a duct to the film. Temperature and flow rate of the air from the duct are controlled. The trimming is made by a shearing slitter. Further, if a distance from a heating position by the warm air to a slitting position of the shearing slitter is from 10 mm to 200 mm, no trimming dusts and the powdery materials are not adhered to a product part of the obtained film, and the slitting of the film forms adequate edges of the product part.

### BACKGROUND OF THE INVENTION

1. Field of the Invention

The present invention relates to a method of cutting a polymer film formed, and especially, a method of cutting a polymer film to be used in an optical field, such as for a polarizing filter, an optical compensation film, a liquid crystal display and the like.

2. Description Related to the Prior Art

A polymer film is used in an optical field, such as for a polarizing filter, an optical compensation film, a liquid crystal display, or the like. Effects for increasing the productivity and an increase the producing speed of the polymer film are made on account of the strong requirement for a lower cost and an enlargement of demands for the above optical productions. Further, in the above optical use, it is extremely required to make that the polymer film has higher and more functions, and corresponding to this requirement, effects for making the polymer film thinner are made.

Usually, in order to obtain the polymer film for the optical use, a solution casting method is performed, in which a dope is cast onto and then peeled as a film from a support and the peeled film is dried. The solution casting method is a representative method of producing the polymer film. The produced polymer film is cut to have a predetermined size. For example, the cutting is sometimes made as a slitting the film before winding around a winding shaft in order to obtain the dried polymer film having the predetermined size, and the cutting is sometimes the sheet-cutting of the continuous film into film sheets having a predetermined length. Further, the continuous film is unwound from a roll and then a coating solution is applied thereon, and thereafter the edge portions are trimmed off or slit off, and otherwise the continuous film is cut into film sheets having a predetermined length.

In the cutting process, if the characteristics in cutting are bad, a crack is formed on a cut surface, and cutting dusts and powdery materials are generated and adhered to parts of the film to be used as the product. In these cases, there are sometimes troubles in transporting the film and the products of the film have defects. Further, if the film is not cut well, the edge parts of the film products is deformed or the product is sometimes torn.

Further, in the above optical fields, the film is drawn corresponding to the use of the film product. However, the drawing makes the film weak. Therefore the film is undermined with cutting characteristics by drawing. Thus the cutting dusts and the powdery materials are more often generated.

Accordingly, in order to perform the cutting better, several proposals are made. For example, if a glass transition temperature is Tg (° C.), a cutting area of the polymer film is heated to be at a temperature in the range of Tg (° C.) to (Tg+100)° C., and then the cutting is made in the cutting area (see, Japanese Patent Laid-Open Publication No. 1-281896). Otherwise, the polymer film is cut, while the residual volatile components and the temperature are kept in a predetermined range (see Japanese Patent Laid-Open Publication No. 9-85680). Preferably, in this case, the residual volatile components are 1% to 15% and the temperature of the cutting area is from 60° C. to Tg (° C.).

However, in the above methods, the generation of the cutting dusts (and the powdery materials) and the deformantion of the cut film are not prevented completely. For example, even if the solvent content is any value, the polymer film is heated to Tg (° C.) such that the film may become softened and the cutting may be easily performed. In this case, a trimming edge of the film after the cutting is deformed to have a wave-like form or the high edge.

FIG. 6 is a sectional view of a film 101 with a high edge 103 formed on a trimming edge 102 after the cutting. In the cutting processes of the film 101, when a cutter blade cuts the film 101 and leaves the film 101, the trimming edge of the film 101 is adhered to the cutter blades and stretched so as to form the high edge 103. In this case, the film 101 is too soft and the viscosity is extremely large.

### SUMMARY OF THE INVENTION

An object of the present invention is to provide a cutting method of a polymer film with a high cutting efficiency for performing the cutting better and reducing the generation of the cutting dusts and the powdery materials.

In order to achieve the object and the other object, in a method of cutting with a cutter a polymer film formed from a polymer, the polymer film is continuously fed, and a controlling temperature T (unit; ° C.) of the polymer film at the cutting such that the temperature T may be satisfy a following formula related to a glass transition temperature Tg (unit; ° C.) of the polymer, Tg−90≦T≦Tg−30.

Preferably, the control of the temperature T is made with use of a heating device, and a distance between a heating position of the heating and a cutting position of the cutting is at least 10 mm and at most 200 mm.

Preferably, both surfaces of the polymer film are heated with use of the heating device. Further, the heating device is preferably an air feeding device and an illuminating device. The illuminating device is an incandescent lamp or an infrared ray heater. Furthermore, the cutter is a rotary type shearing slitter or a rotary type razor cutter.

According to the method of cutting the polymer film of the present invention, a cutting of the polymer film is made better, the generation of the cutting dusts and the powdery materials is reduced. Thus the cutting forms the adequate edges. Further, even in cutting the multi-layer film having a coating layer and the like, the same effectives are obtained, and the film can be cut in a situation that cut-out fragments of the film can be reused.

### BRIEF DESCRIPTION OF THE DRAWINGS

The above objects and advantages of the present invention will become easily understood by one of ordinary skill in the art when the following detailed description would be read in connection with the accompanying drawings.

FIG. 1 is a schematic diagram of a production equipment of a dispersion, a swelling solution and a dope according to the present invention;

FIG. 2 is a schematic diagram of one embodiment of film production equipments to which a solution casting method is applied;

FIG. 3 is an explanatory view illustrating a situation of casting a dope with use of an embodiment of a casting die;

FIG. 4 is an explanatory view illustrating a situation of casting the dope with use of a second embodiment of a casting die;

FIG. 5 is an explanatory view illustrating a situation of casting the dope with use of a third embodiment of plural casting dies;

FIG. 6 is a schematic diagram of another embodiment of film production equipments to which a solution casting method is applied;

FIG. 7 is a sectional view illustrating a film cutting section by a method of cutting a film in a prior art.

### PREFERRED EMBODIMENTS OF THE INVENTION

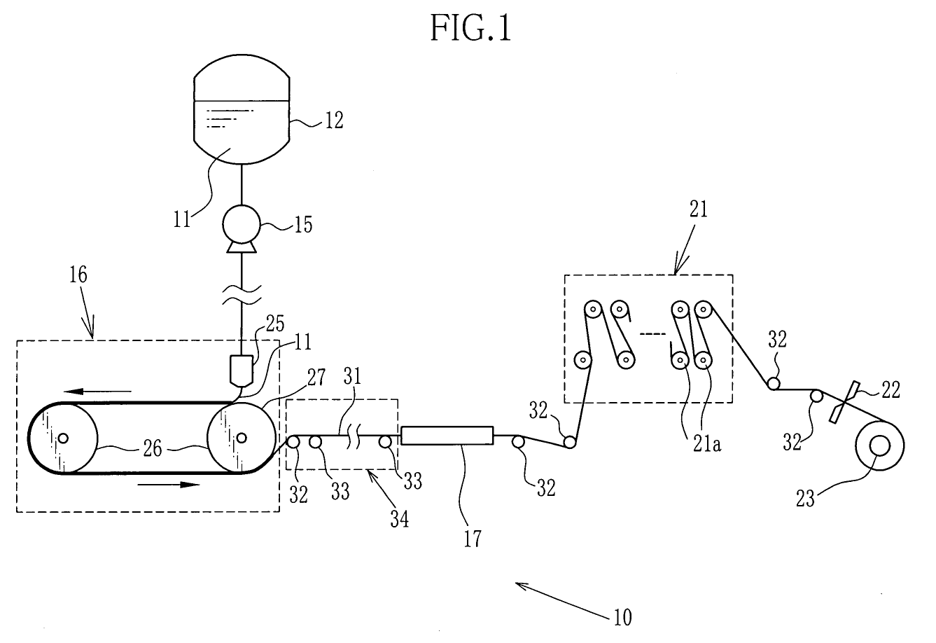

In FIG. 1, a film production equipment 10 includes a reserve tank 12 in which a dope 11 is supplied, a feeding pump 15, a casting apparatus 16, a tenter dryer 17, a drying apparatus 21, a slitting device 22 and a winding apparatus 23. The casting apparatus 16 has a casting die 25 and a belt 27 as a support which is moved with support of back-up rollers 26. Further, in a downstream side from the belt 27, there is a peeling roller 32 for peeling a film 31 from the belt 27. In a downstream side of the belt 27, there is a peel roller 32 for peeling the film 31 from the belt 27. In a downstream side from the peeling roller 32, there are plural rollers 33 for guiding the film 31 in to the tenter dryer stably, and the number of the plural rollers 33 are changed adequately. Further, it is adequately determines whether these rollers 32, 33 are driven or not.

The dope 11 is sent from the reserve tank 12 to the casting die 25 by the feed pump 15. The casting die 25 casts the dope 11 onto the belt 27. The belt 27 is continuously moved in accordance with the rotation of the back-up rollers. When the dope on the belt 27 has a self-supporting property, it is continuously peeled as the film 31 with drive and rotation of the peeling roller 32 disposed in the most upstream position in a passing area 34. Note that the peeling may be made with use of other peeling device by applying a tension in the transporting direction of the film 31 from a downstream side from the belt 27.

The film 13 is transported through the passing area 34 to the tenter dryer 17, in which a width of the film is regulated. The tenter dryer 17 has tenter clips (not shown) for holding both edge portions of the film 31, and the tenter clips run on tracks with the holding to transport the film 31. The tenter clips are controlled to open and close automatically for performing the holding and the releasing of the film 31. The running tenter clips open at a release position near an exit of the tenter dryer 17 so as to release the film 31. Note that pin clips may be used instead of the tenter clips.

The film 31 in the tenter dryer 17 is sent to the drying apparatus 21 by rollers 32 for the support or transfer. In the drying apparatus 21, the film 31 is transported with support of many rollers 21a and dried. After the drying apparatus 21, both edge portions are trimmed off by the slitting device 22, and a remaining middle portion is wound as a product by a winding device 23. Note that the explanation of the slitting device 22 is made in detail later, and some parts and members are not illustrated in FIG. 1 for easiness of understanding.

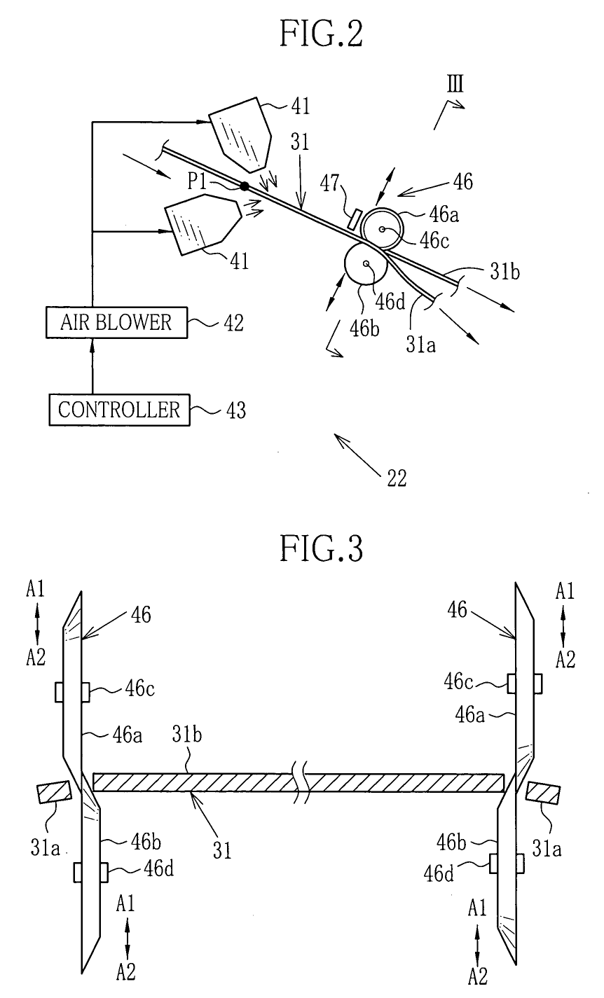

The slitting method of the present invention will be explained with use of FIGS. 2&3. The slitting device 22 includes ducts 41, an air blower 42 and a controller 43 for heating the film 31, and further includes a rotary type shear slitter 46 as a Goebel-type shear slitter. Each slitter 46 is constructed an outer blade 46a and an inner blade 46b. The outer and inner blades 46a, 46b are connected to a controller (not shown) for controlling the shifts of them in directions A1, A2. The ducts 41 are disposed below and above the film 31 in FIG. 2. Note that the ducts 41 are not illustrated in FIG. 3 for easiness of this figure. The duct 41 has a slit (not shown) for supplying air toward the film 31. Each slit is provided with plural lids arranged in a widthwise direction of the film so as to independently open and close the slit. Thus the air can be fed only to a predetermined position of the transported film 31. The slitting device 22 can be used for the films having different widths.

In this embodiment, the ducts 41 are provided for heating slitting areas in which the slitting to be made at the slitting position. a heating air which is supplied from the air blower 42 is fed to a predetermined position. The controller 43 is connected to the air blower 42 so as to control the temperature and the flow rate of the airs supplied to the ducts 41. Thus the air having the predetermined temperature is fed out from the ducts 41 at the predetermined flow rate.

Thereby, a transporting speed, an air feeding position and a slitting position are taken into a consideration, in the determination of the temperature and the flow rate of the air fed from the ducts 41. In the present invention, if the glass transition temperature of the polymer of the film 31 is represented as Tg, the condition of feeding the air is determined such that the temperature T1 of the film 31 at the slitting may be in the range of (Tg−90)° C. to (Tg−30)° C. Note that the polymer above the value Tg has a rubber-like elasticity. If the temperature T1 of the film 31 at the slitting is lower than (Tg−90)° C., the elasticity of the polymer is not enough. Therefore the film 31 splits from sides formed by the slitting, and the trimming dusts and the powdery materials are generated. Further, if the temperature T1 of the film at the slitting is larger than (Tg−30) ° C., the film 31 becomes extremely soft. Therefore the high edges are formed in a trimming edge of a product portion 31b after the both edge portions 31a are trimmed off. Note that the temperature T1 is a temperature of the slitting areas of the film 31 at the slitting position, and therefore it is not necessary that all positions of the film 31 have the temperature T1. Furthermore in the determination of the temperature and the flow rate of feeding the air, it is preferable to take account of heat conductivity, specific heat and the like, when the film 31 is more than 100 μm in thickness. However, when the film 31 is at most 100 μm and especially at most 80 μm in thickness, it is not necessary to take account of them.

In the slitter 46, at the start of the slitting, the outer blades 46a and the inner blades 46b respectively shift in the direction A2 and the direction A1 to predetermined positions. Further, at the stop or end of the slitting, the outer blades 46a and the inner blades 46b respectively shift in the direction A1 and the direction A2. The outer and inner blades 46a, 46b are respectively provided with rotary shafts 46c, 46d on rotational axes. When the outer and inner blades 46a, 46b rotate, the edge portions 31a of the transported film 31 are trimmed off. Thereafter the product portion 31b of the film 31 is wound by the winding device, and the edge portions 31a are recovered for reusing. Note that the slitter 46 may be previously set on the transporting path of the film 31 in the situation that the outer and inner blades 46a, 46b are partially overlapped as shown FIG. 3. In this case, the slitters 46 are shifted from the outside toward the slitting position for starting the slitting of the transported film 31.

Actually, the measurement of the temperature during the trimming is difficult. Accordingly, in this embodiment, an infrared ray thermal sensor 47 is provided just before the slitter 46, and the measured value of the thermal sensor 47 is regarded as the temperature T1 at the slitting. The thermal sensor 47 may be connected to the controller 43. In this case, the measurement data is sent from the thermal sensor 47 to the controller 43, and determines the conditions of supplying the air on the basis of the measured data.

As described above, in the present invention, the film 31 is heated to a predetermined temperature before the trimming, and the temperature at the trimming is in the range of (Tg−90)° C. to (Tg−30)° C. Thus the trimming dusts and the powdery materials are not generated and the condition of a trimming edge of the production portion 31b is good after the trimming. For example, in the cellulose acylate film, since the glass transition temperature is 130° C., the film 31 has the temperature about 50° C. at the trimming such that the trimming efficiency may become higher.

When the air is fed out from the duct 41 onto the film 31, there is a region for application of the air on the film 31. Thus the transported film 31 is heated from an uppermost position P1 of the region. In this embodiment, a distance from the position P1 to the slitter 46 is from 10 mm to 200 mm. When the distance is shorter than 10 m, the slitter 46 and the whole of the slitting device 22 are heated. Thus the trimming efficiency becomes lower and the life of the slitter 46 becomes shorter. Further, when the distance is longer than 200 mm, the temperature of the film changes too much before the trimming, not so as to be in the predetermined range at the trimming. The distance is preferably from 10 mm to 100 mm, and particularly from 10 mm to 50 mm. In the present invention, the distance is predetermined such that the temperature at the trimming may not be lower than (Tg−90)° C. Otherwise, a heating temperature of the air fed out from the duct is preset on account of the distance and the transporting speed, such that the temperature at the trimming may be in the range of (Tg−90) ° C. to (Tg−30)° C. In this case, the heating temperature is determined depending on the distance and the transporting speed.

In the present invention, the temperature of the film 31 is controlled for regulating mechanical properties of the polymer, such as a rupture elongation, elastic modules and the like. Namely, in the present invention, a temperature dependence of the mechanical properties of the polymer is a criterion for determining the temperature at the trimming. Accordingly, the present invention is not restricted in the case that the polymer has the glass transition temperature Tg. For example, even when the polymer has the glass transition temperature, there are some elements, for example the polymerization condition, the degree of polymerization, the molecular arrangement and the like, in effect of which the glass transition temperature Tg sometimes cannot be detected. Further, whether the polymer has the glass transition temperature depends on whether the polymer is crystalline or not. Further, in the film production, a necessary amount of several sorts of the additives are added to the film, or several processing, such as the stretching and the like, is made. Even when the polymer as the main component of the film is the same, the above mechanical strength of the produced film sometimes shows a different temperature dependence. In these cases, data of the temperature dependence of the mechanical properties, such as the rupture elongation, elastic modules and the like, of the polymer in the film to be trimmed is previously obtained, and the heating temperature of the air from the duct 41 is determined on the basis of the data.

In following, processes of obtaining the range of the trimming temperature will be explained. As the polymer, cellulose acetate (TAC) is used. The temperature dependence of the mechanical properties of cellulose acetate is measured to obtain the data. The rupture elongation is an elongation percentage until the rupture of the film in applying a tensile force. A distance of optional two points before applying the tensile force is x1, and a distance of the two points after applying the tension (at the rupture) is x2. The rupture elongation (%) is obtained from the formula {(x2−x1)/x1}×100. The measurement of the distances are made with use of tension testing machine in the market (trade name; Tensilon and the like), and the like. As described before, the rupture elongation and the elastic modules become different depending on a film processing method (such as the stretching method and the like) and the sorts of the contained additives. However, usually in the thermoplastic polymer film, the rupture elongation becomes larger and the elastic modules becomes smaller in the temperature range from 20° C. to 140° C. such that the film may be easily stretched, if the temperature becomes higher.

The embodiment in which the TAC is used has the similar tendency. When the rupture elongation is in the range of about 40±10 (%) and the elastic modules is in the range of about 3±1.5(Gpa), the film 31 can be trimmed well. In this case, the temperature of the film 31 is from (Tg−90)° C. to (Tg−30)° C. If at least the surface temperature of the film 31 is controlled in this range, the rupture elongation and elastic modules are controlled so as to be adequate values for the trimming. If the trimming temperature is less than (Tg−90) ° C., the elastic modulus becomes higher than the above range, and the rupture elongation becomes too small. Thus the rupture elongation and elastic modules becomes inadequate for the trimming. If the trimming temperature is more than (Tg−30) ° C., the rupture elongation becomes larger than the above range, and the elastic modules becomes too low. Thus the film becomes soft and easily extended so as to have wave like deformation and other deformation. Note that in this embodiment, the estimation of the trimming properties is made by observing the shape of the trimming edges of the production part 31b after the trimming and the amount of the trimming dust and the powdery materials on a trimming surface which is formed by the trimming.

The TAC is a polymer having the glass transition temperature at 130° C. However, as described above, the heating temperature can be determined on account of the mechanical properties such as the viscoelasticity and the like, without taking the criterion of the glass transition temperature Tg. Therefore, the heating temperature can be determined also in the case of the polymer having no glass transition temperature, the polymer whose glass transition temperature is too low and lower than a deflection temperature under load, and the like.

In the present invention, an opening of the duct 41 is a slit extending in the widthwise direction of the film. However, the shape of the opening is not restricted in it. So far as the air is fed to the predetermined range under the predetermined conditions, a multi-hole plate may be provided so as to feed out the air through many holes thereof.

In this embodiment, the ducts 41 are disposed in both sides of the film so as to heat the both surfaces simultaneously. However, at first the one surface and thereafter the other surface may be heated sequentially. Furthermore, so far as the slitting area is heated to the predetermined temperature, the heating can be made only in the one side, and the present invention is not restricted in the heating in the both sides. Note that the heating period is preferably short on account of the decomposition of the film 31. Further, on account of the efficiency, the thermal energy is preferably applied to the both surfaces.

Further, an aspiration device may be provided near the slitting position of the film 31, the slitter 46 or the like so as to aspirate the small amount of the trimming dusts and the powdery materials around the slitting position.

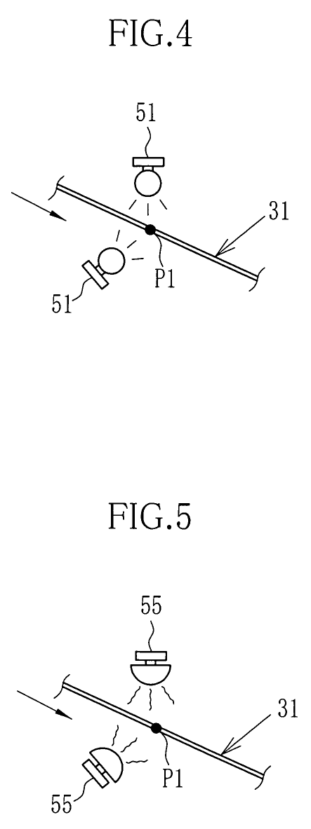

Further, in this embodiment, the heating method is not restricted in feeding the heating air. As shown in FIG. 4, a light source, such as an incandescent lamp 51 and the like, may be used instead of the duct 41 and the air blower 42 (see, FIG. 2), so as to heat the film 31 by applying the thermal energy. Further, as shown in FIG. 5, an infrared ray heater 56 and the like may be provided for the heating instead the duct and the air blower. These light source, the infrared ray heater and the like are effective in the points that the fluttering of the film caused by feeding the air does not occur and that the dusts and the powdery materials around the film are prevented from being adhered to the film. Further, single one or a combination of these methods can be adopted. In the present invention, as just described, the heating method is not restricted. However, it is preferable to apply the thermal energy from at least one of the incandescent lamp and the infrared ray heater, on account of operationality, costs and the like.

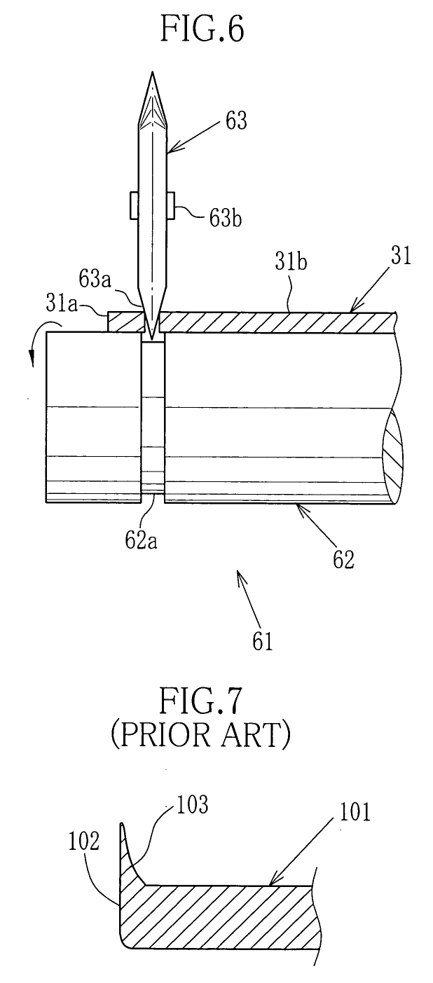

In FIG. 6, a score type slitter 61 as a rotation type razor slitter is used instead of the shear slitter 46. The score type slitter 61 has a roller 62 and a rotary blade 63, and the roller 62 supports the film 31 around a rotary shaft 63. On a periphery of the roller 62 is formed a groove 62a in a side in the rotary direction of the roller 62. The slitting area of the film 31 moves on the groove 62a. The rotary blade 63 has a disc-like shape and a slitting portion 63a is formed on a periphery of the rotary blade 63. The rotary blade 63 rotates around a rotary shaft 63b. The film 31 is sandwiched between the rotary shaft 63 and the roller 62 while being transported, and the slitting portion 63a is positioned in the groove 62a of the roller 62 with trimming the film 31 continuously in accordance with the rotational speed of the roller 62. The rotational speed of the rotary blade 63 may be different from that of the roller 62. When the film 31 is trimmed in this method after the heating the film 31, the adequate slit portion can be obtained without the generation of the dusts and the powdery materials. Note that the slitting portion 63a of the slitter blade 63 may be a double edge type or a single edge type. However, in order to obtain the adequate slit portion by equalizing the stress on the both surfaces in the slit portion, the slitting portion is preferably the double edge type as shown in FIG. 6.

In the present invention, the slitting method is not restricted in using the rotary type shear slitter and the rotary type leather slitter, and the slitters already known can be used. However it is especially preferable to use the rotary type shear slitter and the rotary type leather slitter such as the score type slitter.

In the present invention, the content of the solvent in the film 31 at the trimming is not restricted especially. Accordingly, the trimming can be made after the peeling, especially after the stretching in the tenter dryer, although the trimming is made just before the winding in this embodiment. Note that when it is designated to make the trimming of the film 31 containing the solvent, the upper limit of the heating temperature is set to be lower than the boiling point of the solvent. If the mixture solvent is used, the upper limit is the lowest boiling point among compounds of the mixture solvent. Otherwise, when the film containing the solvent is heated, the compositions of the solvent evaporates from the inner side of the film rapidly to generate bubbles, voids, breakings, swelling and the like. Further, when the film 31 contains the additives (such as the lubricant, UV-absorbing agent and the like), it is necessary to set the heating temperature on account of the heat characteristics and the volatility. Especially when the film 31 contains the solvent, it is preferable to previously obtain a data of evaporation behavior and to set the heating temperature on the basis of the obtained data. Thus the generation of the voids, swelling and the like are more effectively reduced.

When the trimming of the film containing the solvent is made, it is preferable to determine the heating temperature on the basis of data of viscoelasticity at the content of the solvent. The mechanical properties before the heating are different from those after the heating. The difference becomes more larger when the film contains the solvent than when the film doesn't contain the solvent. In this meaning, the content of the solvent is preferably low, and the upper limit of the content is about 25%, and particularly 20%. Note that the content of the solvent is calculated from a formula, when the mass of the sample film at the sampling is x (unit; g) and the mass of the sample film after the drying is y (unit; g):
{(x−y)/y}×100.
If the content of the solvent is larger than 25%, the voids and the swelling often occur.

If it is designated to trim the film containing the solvent, the present invention is not restricted in the solvent of this embodiment, and other compounds for the solvents that are already know can be used. For example, as such compounds, there are hydrocarbon halides, alcohols, ethers, esters, ketones and the like, and single one or the mixture of these compounds can be used as the solvent. Further, when it is designated that several sorts of the additives are contained in the film, the additives are not restricted, and for example, the plasticizer, the UV-absorbing agent, the dyestuff, the optical anisotropic compound, matting agent and the like.

Further, the present invention is especially effective for trimming the film being from 20 μm to 200 μm in thickness. Usually, while the transporting speed of the film becomes larger, the static electrical charge is generated, and therefore more of the trimming dusts and the powdery materials are adhered. However, the present invention is effective since the generation of the trimming dusts and the powdery materials is reduced. Further, the present invention is especially preferable for trimming the film being from 40 μm to 100 μm in thickness.

Further, in this embodiment, the film is a TAC film. However, the present invention is not restricted in it. Further, the present invention is not restricted in using the film produced by the solution casting method. Namely, the present invention has the same effects also when a polymer film produced by a melt-extrusion method and the like is used.

As the polymer to be used in the present invention, there are cellulose acylate (such as the TAC of this embodiment), polyesters (such as polyethylene telephthalate (PET), polyethylene-2,6-naphthalate (PEN) and the like), polyolefines (such as polyethylene (PE) and the like), polystyrene, polyvinylchloride (PVC), polyvinylidene chloride, polycarbonate (PC), polyamide (PA), polyimide (PI), and the like. Note that when the polymer is the polyimide, a solution of polyamic acid, precursors of the polyimide, is cast and dried with the heating so as to remove the solvent and make the cross-linking. Thus film is obtained. Therefore, the trimming may be made before or after the completion of the cross-linking. However, when the TAC is used as the polymer, the effect of the present invention becomes the largest.

Further, the present invention is the cutting method of the polymer film. However, the cutting method of the present invention can be utilized for cutting the polymer products other than the polymer film, for example, fiber, tape, hollow fiber and the like.

Furthermore, the present invention is also effective when the film has not only a single layer structure but also a multi-layer structure. Further, the case of the film having the multi-layer structure, a sequential casting method and a co-casting method can be used. Note that the film having the multi-layer structure is trimmed in the situation that the solvent is removed. In this case, it is prevented that the combination force of the polymer in one layer and the boundary in the solvent becomes larger when the heating is made for regulating the mechanical properties such as the elastic modules and the like.

An example of the film having the multi-layer structure (hereinafter multi-layer film) is a polarizing filter, an optical compensation film and the like. In these multi-layer films, each of superimposed layers is formed from different polymers and has a different function. In the present invention, even when such multi-layer film is trimmed, the trimming dusts and the powdery materials don't occur and the adequate trimming edge can be obtained in the film after the trimming. Thus, since the multi-layer film obtained by the cutting method of the present invention can be trimmed without increasing the combination force between the layers, each layer can be separated by a predetermined treatment method and used for reusing. Preferably, if the multi-layer film is trimmed, the lowest glass transition temperature among the used polymer is determined to the upper limit of the temperature T1 of the film at the trimming, and thereafter the heating is made.

Furthermore, if the multi-layer film has both layer formed of a polymer having the glass transition temperature and layer formed of a polymer having no glass transition temperature, the upper limit of the temperature of the film and the heating temperature are determined on the basis of not only the glass transition temperature but also the deflection temperature under load and the melting point. Otherwise, in this case, the data of the viscoelasticy of each polymer is compared, and the heating temperature is preferably determined on the basis of the data.

### EXAMPLE 1

### Experiment 1

Examples of the present invention will be explained in followings. The film is produced with use of the film production equipment 10. in the following explanation, the composition and the preparation method of the polymer solution (dope) will be described, and then the film production method, and the estimation and result of the properties of the obtained film are explained. Thereafter, the trimming conditions with use of the slitting device 22 by the slitting method of the present invention will be explained.

[Composition of Dope]

| | | |
|---|---|---|
| Cellulose triacetate particles | 100 | pts. by mass |
| (substitution degree, 2.84; viscometric average | | |
| degree of polymerization, 306; water content, 0.2 | | |
| mass %; viscosity of 6 mass % in methylelchloride | | |
| solution, 315 mPa · s; averared particle diameter, | | |
| 1.5 mm; standard deviation of particles, 0.5 mm). | | |
| Dichloromethane (first solvent compound) | 320 | pts. by mass |
| Methanol (second solvent compound) | 83 | pts. by mass |
| 1-Butanol (third solvent compound) | 3 | pts. by mass |
| Agent for adjusting light characteristics | 1.0 | pts. by mass |
| UV-absorbing agent a | 0.7 | pts. by mass |
| (2-(2′-hydroxy-3′,5′-di-tert-butylphenyl)benzotriazol) | | |
| UV-absorbing agent b | 0.3 | pts. by mass |
| (2-(2′-hydroxy-3′,5′-di-tert-amilphenyl)-5- | | |
| chrolobenzotriazol) | | |
| Citric acid ester mixture | 0.006 | pts. by mass |
| (mixture of citric acid, citric acid monoethyl ester, | | |
| citric acid diethyl ester, and citric acid triethyl ester) | | |
| Particles | 0.05 | pts. by mass |
| (silicone dioxide particles having diameter of 15 nm, | | |
| and Mohrs hardness about 7) | | |

[Cellulose Triacetate]

Cellulose triacetate used in this experiment contains remaining acetylic acid of at most 0.1 mass %; remaining Ca of 58 ppm; remaining Mg of 42 ppm; remaining Fe of 0.5 ppm; free acetylic acid of 40 ppm and sulfate ion of 15 ppm. The substitution degree of the acetyl group for hydroxyl group at 6th position was 0.91, and 32.5% in total acetyl groups was substituted for the hydroxyl group at 6^{th} position. The weight percentage of the material extracted with acetone was 8 mass %, and the ratio of the weight average molecular weight to the number average molecular weight was 2.5. Further according to the obtained TAC, a yellow index was 1.7, the haze was 0.08 and the transparency was 93.5%. The glass transition temperature Tg (measured by DSC) was 160° C., and the calorific value in crystallization was 6.4 J/g. The TAC was produced by polymerization of cellulose as the raw material obtained from the cotton. In the followings, this TAC is called a cotton TAC

(1-1) Preparation of Dope

The dope was prepared with use of a dope preparation apparatus. Plural solvent compounds were mixed and enough stirred in a stainless dissolution tank of 4000 L with stirrer blades, so as to obtain a mixture solvent. Note that water contents were at most 0.5 mass % in all of the solvent compounds. Then, the TAC particles (flake particles) were gradually added through a hopper of the dissolution tank, and thereafter the stirring was made for 30 minutes under predetermined conditions with use of the eccentricity stirrer of a dissolver type that has anchor type blades. The stirring was started at 25° C., and consequently the temperature became 48° C. Further, the additive solvent prepared previously was supplied into the dissolution tank with controlling the flow rate by the valve, such that the mass of the obtained mixture might be 2000 kg in total. When the stirring was end, the high speed stirring with a stirring shaft of the dissolver type was stopped. Thereafter, the stirring was made for 100 minutes at the 0.5 m/sec rotating speed of the anchor type blades. The swelling of cellulose triacetate was made to obtain the swelling solution. Until the completion of the swelling, the nitrogen gas was supplied into the dissolution tank such that the inner pressure of the dissolution tank might be 0.12 MPa. In this case, the concentration of oxygen was less than 2 vol % for preventing the explosion. The water content in the swelling solution was 0.3 mass %.

(1-2) Dissolution, Filtration

The swelling solution was fed from the dissolution tank through a pipe by a pump. The pipe had a jacket, and the swelling solution was heated to 50° C. in the pipe. Thereafter, the swelling solution was heated to 90° C. under the increased pressure at 2 MPa, such that the solute might be completely dissolved. In this heating, the heating time was 15 minutes. Then the obtained liquid was cooled to 36° C. with a temperature controller, and filtrated through a filtration apparatus including a filter of nominal bore diameter at 8 μm. Thus a low concentration dope was obtained. In the filtration apparatus, the primary side pressure was 1.5 MPa, and the secondary side pressure was 1.2 MPa. Further, the filter, a housing and the pipe were produced from a hastelloy alloy which is excellent in corrosion resistance, since they were used at the high temperature. Furthermore the housing and the pipe had jackets in which heat transfer materials were fed for heating or keeping the high temperature.

(1-3) Concentrating, Filtration, Defoaming, Additives

Then the low concentration dope was discharged from the pipe into a flash-evaporation device in which the temperature was 80° C. under the atmospheric pressure, so as to perform a flash evaporation. The evaporated solvent compounds were liquidized (condensed). After the flash evaporation, the concentration of the solid material in the dope was 21.8 mass %.

The liquidized solvent compounds were recovered into a recovering device, and some reclaiming treatments were made in a reproducing device. Then the liquidized solvent was fed to the solvent tank and reused as the solvent. In the flash tank, there were anchor type blades, which were rotated at a predetermined rotation speed so as to make the defoaming. The temperature of the dope in the flash tank was 25° C., and the convection time of the dope in the flash tank was 50 minutes. The dope in the flash tank was sampled, and the shearing viscosity of the sample was measured at 25° C. The measured value was 450 Pa·s at the shearing speed of 10 (sec⁻¹).

Thereafter, a weak supersonic wave was applied to the dope so as to make the defoaming. Then the pressure to the dope was increased to 1.5 MPa by a pump. In this situation the dope was fed through the filtration apparatus, in which the dope was fed through a sintered metal fiber filter (first filter) having minimal nominal bore diameter of 10 μm and then through sintered fiber filter (second filter) having minimal nominal bore diameter of 10 μm. The pressures of the first and second filters were respectively 1.5 MPa and 1.2 MPa, and the secondary side pressure of the first and second filters were respectively 1.0 MPa and 0.8 Ppa. The temperature of the dope after the filtration was controlled to 36° C., and the dope was fed into the stainless stock tank of 2000 L. In the stock tank 12, the dope was stored as the dope 12 in FIG. 1. The stock tank is an anchor type blade thereof and the dope was stirred by rotating the anchor type blade. Note that corrosions and the like were not observed in contacting portions of members or devices to the dope between obtaining the dope before the concentrating to obtaining the dope 11. Further, a mixture solvent A was prepared, which contains dichlorimethane of 86.5 pts. by mass, acetone of 13 pts. by mass, and 1-butanol of 0.5 pts. by mass.

(1-4) Feeding, Adding, Casting, Decompression

The film was produced with use of the film production equipment 10 in FIG. 1. The dope 11 in the reserve tank 12 was fed to the filtration apparatus at high accuracy by driving a gear pump 15. The pump 15 had a function of increasing the primary side pressure, and fed the dope 11 with a feed back control to the upstream side from the pump 15 with use of an inverter motor such that the primary pressure might be 0.8 MPa. The volumetric efficiency of the pump was 99.2%, and the coefficient of fluctuation of the flow rate of the discharged dope 11 from the pump 15 was at most 0.5%. Further, the discharging pressure was 1.5 MPa. Further, the dope 11 was further fed through the filtration apparatus to the casting die 31.

A width of the casting die 31 was 1.8 m, and the flow rate of the dope 11 cast from the slit was controlled such that the thickness of the film 31 after the drying might be 92 μm. Further, the width of the dope cast from the die was 1700 mm. The temperature of the dope 11 was controlled to 36° C. The casting die 31 was provided with a jacket (not shown) into which a heat transfer medium was fed. A temperature of the heat transfer medium was 36° C. at an entrance of the jacket.

The temperature of the casting die 31 and the pipe was kept at 36° C. during the drive of the film production equipment 10. The casting die 31 was a coat hanger type die, and in the casting die 31, there were thickness adjusting bolts which were arranged at 20 mm pitch. The casting die 31 includes an automatically adjusting mechanism of the thickness by the heat bolts. A profile for controlling the heat bolt can be preset, so as to correspond to the feed rate of the pump 15 which was driven by the predetermined program. Thus, except of the edge portions having 20 mm width, the difference of the film thickness between optional two points was at most 1 μm, and the largest difference of the film thickness in the widthwise direction was 3 μm/m. The fluctuation of the film thickness was at most ±1.5%.

Further, a decompression unit was disposed in the primary side of the casting die 31, so as to make the decompression of the primary side of the casting die 31. The degree of decompression in the decompression unit was controlled such that there might be a difference of the pressure in the range of 1 Pa to 5000 Pa between the up- and downstream sides from the bead of the cast dope. The degree of decompression was controlled depending on the casting speed, and the difference of the pressure in both sides from the beads was controlled such that the length of the beads might be a predetermined value. Further, the decompression unit was provided with a device which can set the temperature in the decompression unit to more than the condensation temperature for condensing the solvent vapor. Further, a labyrinth packing (not shown) was disposed near the die lip of the die in the front and back side of the bead. Further, both sides of a die lip are provided with openings. Further, an aspiration device (not shown) for reducing the disorder of edges of the bead was attached to the casting die 31.

(1-5) Casting Die

The materials of the casting die was precipitation hardening stainless steel, whose coefficient of thermal expansion was at most 2×10⁻⁵(° C.⁻¹). The casting die produced of this stainless steel has an almost same resistance of corrosion as that of SUS 316, in an corrosion examination in an electrolyte water solution. Further, the stainless steel of the casting die has such resistance to corrosion that the bores might not be formed on the gas-liquid interface by the pitting corrosion even if it was put into a mixture of dichloromethane, methanol and water. The surfaces roughness of surfaces of the casting die 31 for contacting the dope was at most 1 μm, the straightness was at most 1 μm/m in any directions, and the clearance of the slit was 1.5 μm. In the casting die 31, edge of a contact surface of the die lip to the dope was formed to have a curvature R of at most 50 μm through the slit.

The shearing speed in the casting die 31 was from 1 (1/sed) to 5000 (1/sec). Further, the front edges of the die lips of the casting die 31 was coated by a WC (tungsten carbide) coating in a spraying method.

Further, near the die lip of the casting die 31, in order to prevent to dry and solidify the cast dope 11 locally, the mixture solvent A was supplied at 0.5 ml/min to the interface between the die lip and the both edges of the bead of the cast dope 31. Further, the pressure in the back side of the bead was set to be 150 Pa lower than in the front side. Further, a jacket (not shown) was provided for controlling the inner temperature of the decompression unit to a predetermined value, and a heat transfer medium whose temperature was controlled to 35° C. was fed into the jacket. The aspiration device could be adjusted such that the aspiration air flow might be from 1 L/min to 100 L/min. In the present invention, the aspiration airflow was adequately controlled from 30 L/min to 40 L/min.

(1-6) Metal Support

As the support, the stainless endless belt which was 2.1 m in width and 70 m in length was used. The belt 27 was 1.5 mm in thickness and polished such that the surface roughness might be at most 0.05 μm. The materials of the belt 27 was SUS316 such that the belt 27 might have the enough resistance to corrosion and strength. The fluctuation of the thickness of the casting belt 27 was at most 0.5%. The belt 27 was moved by the backup rollers 32, such that the tensile force of the belt 27 in the conveying direction might be the predetermined value and the difference of the speed of the belt 27 and the backup rollers might be at most 0.01 m/min. Further, the fluctuation of the conveying speed of the belt 27 was at most 0.5%. Further, positions both side ends of the belt 27 were detected and regulated such that meandering of the belt 27 in the widthwise direction might be at most 1.5 mm. Further, the positional fluctuation between the edges of the die lips and the belt 27 in the vertical direction was at most 200 μm. Note that the belt 27 was disposed in a casting chamber (not shown) having a controlling device of wind pressure. The dope 11 was cast on the belt 27 by the casting die 31.

The backup rollers 32 can be supplied therein with a heat transfer medium so as to control the temperature of the belt 27. The backup roller 32 in the side of the casting die 31 was supplied with the heat transfer medium whose temperature was 5° C., and another backup roller 32 was supplied with the heat transfer medium whose temperature was 40° C. The temperature of the surface of a middle in the widthwise direction of the belt 27 was 15° C. just before the casting, and the difference between the both sides was at most 6° C. Note that the belt 27 preferably had no defects of the surface, and three were no pin holes of more than 30 μm. Further there were at most 1 pin hole of 10 μm to 30 μm, and at most 2 pin holes of less than 10 μm.

(1-7) Casting, Drying

The temperature in the casting chamber was kept at 35° C. The cast dope forms a casting film on the support, and a drying air was fed in a parallel to the casting film so as to dry it. the overall heat transfer coefficient from the drying air to the casting film was 24 kcal/m²·hr·° C. The temperature of the drying air was 135° C. in the upstream side and 140° C. in the downstream side in an upper convey path of the belt 27. Further, the temperature of the drying air was 65° C. in an lower convey path of the belt 27. The saturated temperature of each drying air was about −8° C. The concentration of oxygen in the atmosphere in the drying in the upper path was kept at 5 vol %. In order to keep the concentration of oxygen at 5 vol %, the nitrogen gas was substituted for the air. Further, in order to recover the solvent vapor in the casting chamber, a condenser was provided, and the temperature at the exit of the condenser was set to −10° C.

In the casting chamber, there was a wind shielding device such that the drying air was shielded not so as to reach to the casting film for a five seconds after the casting. The fluctuation of the static pressure near the casting die 31 was in the range of ±1 Pa. When the content of the solvent in the casting film become 50 mass %, the casting film was peeled as the film from the belt 27 with support of the peeling roller. Note that when the weight of the sampling film was y1 just after the sampling and y2 after the drying, the content of the solvent by dry basis was calculated from a formula {(y1−y2)/y2}×100. The peeling tension was controlled to the predetermined value, and the peeling tension (drawing force of peeling roller) to the conveying speed of the belt 27 was adequately adjusted in the range of 100.1% to 111%, so as to reduce the defect of the peeling. The surface temperature of the film at the peeling was 15° C. The average drying speed on the belt 27 was 60 mass %/minute, for evaporating the solvent by dry basis. The solvent vapor generated in the drying was condensed at −10° C. in a condenser, and recovered into a recovering device. The water content in the recovered solvent was controlled to at most 0.5%. The drying air from which the solvent vapor was removed was heated again and reused as the drying air. The film was further transported with use of rollers to the tenter dryer 17. In the transporting, the drying air at 40° C. was fed from an air blower (not shown) toward the film 31. Note that while the film 31 was transported in the passing area 34, a predetermined tensile force was applied to the film 31.

(1-8) Transporting by Tenter Dryer, Drying, Slitting

In the tenter dryer 17, the edge portions of the film 31 were held by the clips and the film was transported in a drying zone of the tenter dryer 17. In the tenter zone, the drying air was applied to dry the film 31. The clips were cooled by feeding the heat transfer medium of 20° C. The transporting of the clips in the tenter dryer 17 was made with use of a chain, the fluctuation of the speed of a sprocket of the chain was at most 0.5%. Further, the temperature in the tenter dryer 17 was 140° C. The composition of the drying air was the same as the saturated gas at −10° C. The averaged drying speed in the tenter device 17 was 120 mass %/minute in the evaporation of the solvent by dry basis. The conditions of the drying zone were adjusted such that the amount of the remaining solvent in the film 31 at the exit of the tenter dryer might be 7 mass %. In the tenter dryer 17, the stretch of the film 31 was made in the widthwise direction with transporting the film 31. Note that when the width of the film 31 before the stretching was 100%, the width after the stretching was 103%. The stretch ratio in a transporting direction (or machine direction) by stretching from the peeing roller 32 to the tenter dryer 17 was 102%. The stretch ratio in the tenter dryer 17 was controlled so as to be the predetermined value. Further, when the length from the entrance to the exit of the tenter dryer was a tenter length and the length from starting to ending the clipping was a clipping length, a ratio of the clipping length to the tenter length was 90%. The solvent vapor generated by the evaporation in the tenter dryer 17 was condensed at −10° C. and then recovered. The condenser was provided for recovery, and the temperature at the exit was −8° C. The water content in the condensed solvent was controlled to at most 0.5 mass %, and then reused.

In 30 seconds from the exit of the tenter dryer 17, the edge portions of the film 31 were trimmed by a similar slitting device (not shown) to the slitting device 22. The trimming in the examination will be explained later.

(1-9) Drying, Neutralization

The film 31 was further dried at a high temperature by the drying apparatus 21 including the rollers 21a. The drying chamber 21 was separated into four sections, into which the respective drying airs were fed from the upstream. The temperature of the drying air into the most upstream section was 120° C., and that into the other sections was 130° C. The transporting tension applied to the film 31 by the roller 21a was controlled, and the drying was made for 10 minutes such that the content of the remaining solvent might be 0.3 mass % at last. A lap angle (a central angle of circular arc corresponding to a region of the roller being in contact with the film) was 90° or 180°. The materials of the roller 21a was aluminum or carbon steel, and the hard chromium plating was made on the surface. A surface of some rollers 21a was flat, and a matting treatment was made on a surface of other rollers by the shooting. The positional shift of the film by the rotation of the roller was at most 50 μm. Further, the bending of the roller 21a after applying the tension was at most 0.5 mm.

The solvent vapor in the drying air was adsorbed to an adsorptive material in an adsorbing device (not shown), so as to remove the solvent vapor from the drying air. The adsorptive material was an activated carbon. The desorption was made with use of a dried nitrogen gas. The recovered solvent was reused as the solvent for preparation of the dope after the water content was adjusted to 0.3 mass %. The drying air contains not only the solvent vapor but also the plasticizer, the UV-absorbing agents, and other materials having high boiling point. Therefore these are removed with cooling by a cooling device and an adsorber (absorber) for the recycling. Then the adsorbing conditions were controlled such that the VOC (volatile organic compounds) in the exhausted gas to the outside might be at most loppm. Furthermore, 90 mass % of the solvent vapor was recovered by the condensing method, and the remaining solvent vapor was recovered by the adsorption.

The dried film 31 was transported to a first control chamber (not shown) for controlling moisture after the drying device 21. In a space between the drying device 21 and the first control chamber, a drying air at 110° C. was fed. Into the first control chamber was fed a drying air whose temperature was 50° C. and dew point was 20° C. Further, in order to prevent the curling of the film 31, the film was further fed to a second control chamber (not shown) for controlling moisture. In the second control chamber, the drying air at 90° C. with 70% humidity was directly applied to the film 31.

(1-10) Conditions of Knurling and Winding

The film 31 after the moisture control was cooled to at most 30° C. in the cooling chamber, and then the both edge portions were trimmed off by the slitting apparatus 22. A neutralization apparatus (or antistatic apparatus), for example neutralization bar, was disposed such that the charged electrostatic potential of the transported film 31 might be always in the range of −3 kV to +3 kV. Further, on both trimming edges of the film 31 after the trimming, the knurling was made on both trimming edges of the film 31 by a knurling roller. The performance of the knurling was made by an embossing process on one surface of the film 31. The width of the knurling was 10 mm, and the pressure of the knurling roller was determined such that the averaged height of each projection formed by the knurling might be 12 μm “Aug.” larger than an averaged thickness of the film 31.

Further, the film 31 was transported to the winding apparatus 23 in which the inner temperature and the humidity were respectively kept 28° C. and 70%. Further, A neutralization apparatus with discharging an ion wind was disposed such that the charged electrostatic potential of the transported film 31 might be always in the range of −1.5 kV to +1.5 kV. The obtained film was 1475 mm in width and 92 μm in thickness. The diameter of the roller of the winding apparatus 23 was 169 mm. The tension was controlled to the predetermined values at the start and the end of the winding. The total length of the film 31 was 3940 m. The displacement length (or an oscillation width) of the film 31 was +5 mm during the winding, and the fluctuation cycle of winding the film around the winding shaft was 400 m. Further, the pressure of the press roller to the winding shaft was controlled so as to be the predetermined value. The film 31 at the winding had the temperature at 25° C., the water content of 1.4 mass % and the content of the remaining solvent at 0.3 mass %. The averaged drying speed of the solvent by dry basis through all processes was 20 mass %/min. The winding looseness and the wrinkles were not observed, and the winding fluctuation didn't occur in the impact test at 10 G. Further, the appearance of the film roll was good.

The film roll was stored in a storage rack at 25° C. and at 55 RH of a relative humidity for one month. Thereafter the same examination was made as above. There were no difference between the two examinations, and no adhesion of the film didn't occur in the film roll. Further, after the film production, any fragments of the casting film formed of the dope 11 didn't remain on the belt 27.

(1-11) Evaluation and Result

The criterions for evaluating the sampled obtained in the Examples will be described below.

(1) Stability of Solution

After the concentrating, the dope 11 was sampled. The sample was stationary kept at 30° C., and observed to following grades A-D.
A: transparency and uniformity of the solution were kept until 20 days,
B: transparency and uniformity of the solution were kept until 10 days, but white turbidities were observed after 20 days,
C: transparency and uniformity of the solution were recognized just after the preparation of the solution, but the gelation was observed after one days such that the solution might be non-uniform,
D: the swelling and the dissolution were not recognized, and the produced solution was neither transparent nor uniform.

(2) Surface Condition

The observation of the film was made with eyes, and the estimation of the surface conditions were made as follows.
A: the film surface was smooth
B: the film surface was smooth but some foreign materials were observed
C: the slight unevenness was observed on the film surface and foreign materials were clearly observed
D: The unevenness was observed, and many foreign materials were observed.

(3) Moist-Heat Resistance of the Film

1 g of the film 31 was cut as the sample, which was folded up and contained in a glass bottle of 15 ml. Then the conditions were adjusted to 90° C. of the temperature and 100% RH. Thereafter the sample was tightly stored with keeping the inner temperature at 90° C., and removed after 10 days. The condition of the film 31 was observed, and the estimation was made as follows.
A: bad conditions weren't especially observed,
B: smell of decomposition was perceived slightly,
C; smell of decomposition was perceived so much
D; smell and deformation of decomposition was perceived

The stability of the dope 11 was A. Further, the surface condition of the obtained film was A, and the tearing of the film was made at 16 g. The film was not damaged until bent 71 times. Further, the content of the remaining acetic acid was less than 0.01 mass %, that of Ca was less than 0.05 mass %, and that of Mg was less than 0.01 mass %. The total thickness of the cellulose triacetate film was 80 μm+1.5 μm. The estimation of the thickness was made in a front end portion, a middle portion and a back end portion in the lengthwise direction, and in the both trimming edges and the middle part in the widthwise direction. It was previously examined that the error of the data was at most 0.2%. Further, the lengthwise and widthwise averaged heat shrinkage was −0.1% under the conditions of 80° C., 90% RH, and 48 hours. Thus the heat-shrinkage of the film 31 hardly occurs. Further, at the exit of the tenter dryer 17, the content of the remaining solvent in the film 31 was 7 mass %. In a silo, the concentration of the solvent vapor was at most 25%.

Further, the obtained film 31 had a haze 0.3%, a transparency at 92.4%, the wavelength inclined width of 19.6 nm and the wavelength limit at 392.7 nm. Further, the edges of the absorbed wavelength at 374.1 nm and 380 nm was 2.0%. The in-surface retardation Re was 1.2 nm, the thickness retardation Rth was 48 nm. The orientation axis of molecules was 1.4°. The elastic modules were 3.54 GPa in the lengthwise direction and 3.45 GPA in the widthwise direction. Tensile strength was 142 MPa in the lengthwise direction and 141 MPa in the widthwise direction. the stretch ratio was 43% in the lengthwise direction and 49% in the widthwise direction. The alkaline hydrolyzable was A, and the curl value was −0.4 at 25% RH, and 1.7 in the wet condition. Further, the water content was 1.4 mass %, and the content of the remaining solvent was 0.3 mass %. The heat shrinkage was −0.09% in the lengthwise direction and −0.08% in the widthwise direction. The observed foreign materials was lint whose number was 5 per 1 m. Further, the number of the luminescent spot in the range of 0.02 mm to 0.05 mm was less than 10 in 3 m, that in the range of 0.05 mm to 0.1 mm was less than 5 in 3 m, and that at least 0.1 mm was 0 (zero). The sample was excellent for the optical use. Further the adhesion after the casting was not observed (estimation was A), and the moisture permeability was also good (estimation was A).

The slitting method of the film by the slitting device 22 in the above film production process will be explained now. The thickness of the film was 92 μm. As shown in FIGS. 2&3, the film was heated by a hot air before the trimming, and thereafter trimmed by the slitter 46 of the Goebel type shear slitter. The temperature of the film 31 at the trimming was 50° C. Further, the distance from the heating point P1 to the slitting position was 30 mm. Note that the room temperature in the slitting process was 25° C.

As a result of the Experiment 1, the crack of the trimming surface was small, and there weren't any high edge and deformation into the wave-like shape. Although the trimming dusts and the powdery materials was observed, the amount thereof was too small to have an bad influence in practice.

[Examination 2]

The temperature of the film 31 at the trimming was 70° C. Other conditions were the same as Experiment 1. As a result of Examination 2, the crack of the trimming surface was small, and the high edge, the deformation into the wave-like shape, and the trimming dusts and the powdery materials were almost not observed.

[Examination 3]

The temperature of the film 31 at the trimming was 100° C. Other conditions were the same as Experiment 1. As a result of Examination 3, the crack of the trimming surface was small and the trimming dusts and the powdery materials were almost not observed. However, the high edge and the deformation into the wave-like shape were observed.

[Examination 4]

The thickness of the film 31 at the trimming was 100 μm. Other conditions were the same as Experiment 1. As a result of Experiment 4, the crack of the trimming surface was small, and there weren't any high edge and deformation into the wave-like shape. Although the trimming dusts and the powdery materials were observed, the amount thereof was too small to have an bad influence in practice.

[Examination 5]

The thickness of the film 31 at the trimming was 100 μm. Other conditions were the same as Experiment 2. As a result of Examination 5, the crack of the trimming surface was small, and the high edge, the deformation into the wave-like shape, and the trimming dusts and the powdery materials were almost not observed.

[Examination 6]

The thickness of the film 31 at the trimming was 100 μm. Other conditions were the same as Experiment 3. As a result of Experiment 6, the crack of the trimming surface was small and the trimming dusts and the powdery materials were almost not observed. However, since the thickness became larger, the slitting resistance was increased, and therefore the high edge and the deformation into the wave-like shape were observed.

[Examination 7]

The distance from the heating point P1 to the slitting position was 300 mm. Other conditions were the same as Experiment 1. As a result of the Experiment 7, no high edges and no deformations into the wave-like shape were observed. However, the temperature of the film 31 became lower until the film arrived at the slitting position, and the crack and the trimming dusts and the powdery materials were observed.

### EXAMPLE 2

The cellulose triacetate film produced by the solution casting method was trimmed. The score type slitter 61 as shown in FIG. 7 was used instead of the slitter 46 (Goebel type shear slitter) as Experiment 1 of Example 1, and the film was heated by the hot air before the trimming. The heated film was trimmed by the score type slitter 61. Other conditions were the same as in Examination 1 of Example 1.

As a result of Example 2, the crack of the trimming surface was small, and no high edges and no deformation into the wave-like shape were observed. Although the trimming dusts and the powdery materials from the crack was observed, the amount thereof was too small to have a bad influence in practice.

### EXAMPLE 3

The cellulose triacetate film produced by the solution casting method was trimmed. The incandescent lamp 51 as shown in FIG. 5 was used instead of the slitter 46 (Goebel type shear slitter) as Experiment 1 of Example 1, and the film was heated by the incandescent lamp 51 before the slitting. The heated film was trimmed by the score type slitter 61. Other conditions were the same as in Examination 1 of Example 1.

As a result of Example 3, the crack of the trimming surface was small, and no high edges and no deformation into the wave-like shape were observed. Although the trimming dusts and the powdery materials from the crack was observed, the amount thereof was too small to have an bad influence in practice.

### EXAMPLE 4

The cellulose triacetate film produced by the solution casting method was trimmed. The infrared ray heater 55 as shown in FIG. 6 was used instead of the slitter 46 (Goebel type shear slitter) as Experiment 1 of Example 1, and the film was heated by the infrared ray heater 55 before the trimming. The heated film 31 was trimmed by the score type slitter 61. Other conditions were the same as in Examination 1 of Example 1.

As a result of Example 4, the crack of the trimming surface was small, and no high edges and no deformation into the wave-like shape were observed. Although the trimming dusts and the powdery materials from the crack was observed, the amount thereof was too small to have a bad influence in practice.

In Example 1, when the temperature of the film was in the range of (Tg−90)° C. to (Tg−30)° C., the high edge, the crack, the deformation into the wave-like shape, and the generation of the trimming dusts and the powdery materials are prevented such that the trimming of the film may form adequate edges of the product part. Further, in Examples 2-4, the shearing slitter and the laser slitter can be used, and the incandescent lamp and the infrared ray heater can be used. Thus the predetermined efficiency as described above can be obtained stably. Accordingly, in the present invention, the film can be adequately trimmed.

Note that the present invention is not restricted in trimming the film, but may be applied to making the sheet-cutting.

Various changes and modifications are possible in the present invention and may be understood to be within the present invention.

1. A method of cutting with a cutter a film formed from a polymer, comprising:
controlling a temperature T (unit; ° C.) of said film at the cutting such that said temperature T may be satisfy a following formula,
Tg−90≦T≦Tg−30
wherein Tg (unit; ° C.) is a glass transition temperature of said polymer.

2. A method according to claim 1, wherein said film is continuously transported.

3. A method according to claim 2, wherein the control of said temperature T is made with use of a heating device, and a distance between a heating position by the heating device and a cutting position of the cutting is at least 10 mm and at most 200 mm.

4. A method according to claim 3, wherein both surfaces of said film are heated by said heating device.

5. A method according to claim 4, wherein said heating device is an air feeding device and an illuminating device.

6. A method according to claim 5, wherein said illuminating device is an incandescent lamp or an infrared ray heater.

7. A method according to claim 2, wherein said cutter is a rotary type shearing slitter or a rotary type razor cutter.
